(19) United States
(12) Patent Application Publication
(10) Pub. No.: US 2012/0143753 A1
(43) Pub. Date: Jun. 7, 2012

(54) SYSTEM AND METHOD FOR ONLINE BUYING TO AGGREGATE PAYMENTS FROM TWO OR MORE PEOPLE

(76) Inventors: Erwin Luis Gonzalez, Key Biscayne, FL (US); Mary Foden, (US)

(21) Appl. No.: 13/308,138

(22) Filed: Nov. 30, 2011

Related U.S. Application Data
(60) Provisional application No. 61/418,407, filed on Dec. 1, 2010.

(51) Int. Cl. G06Q 20/40

(52) U.S. Cl. 705/41

(57) ABSTRACT

A system and method for implementing a group payment transaction. A group payment transaction is initiated by a group leader. Payment information for a plurality of group members are received. Each group member's credit card is pre-authorized for an agreed to amount, but not finalized until a later time. Upon one or more triggers being satisfied, all of the pre-authorized credit card transactions are captured and finalized. The group may remain open or be closed at this point. If it remains open, additional group members may join the group until a maximum trigger value is satisfied.

### BACKGROUND

Purchasing a product or service for a group of individuals often puts a large burden on a single person that is responsible for payment. Often this group leader will individually pay for the entire product or service, and then ask other group members to reimburse them for the costs. This requires a large expenditure of time to collect each individual payment from the other group members. It also requires that individual to have enough money or credit to cover the entire cost of the transaction.

Alternatively, individuals may pay for an item on their own. However, there are often times when the product or service requires multiple participants, such as chartering a boat or airplane. There are other situations where he reduced price may be negotiated for buying tickets, products or services for a large number of people. For example, a person may desire to purchase a large number of tickets for sporting event or concert. These tickets may be offered at a discounted price for a large group of people. Presently, to take advantage of such offers a single individual from the group is responsible for purchasing all of the tickets as described above.

### SUMMARY

Described herein are social payment solutions that allow a group of individuals to make a payment and easily split the payment amongst the members of the group. These group payments may occur via a website over the Internet. In some embodiments, two or more group members may split the cost of the product, service, or item for sale (hereinafter “offer”).

In some embodiments, a group leader may initiate the group payment transaction. Credit card information from each individual of the group, referred to as a group member, may be received. Each of the credit cards associated with the group members is pre-authorized for payment amount associated with the offer. Once a trigger value is satisfied for the entire group the payment on each of the individual credit cards is captured and finalized. If the trigger value is not satisfied the group remains open, allowing other individuals to join the group. The trigger value may be associated with a minimum number of people required to form a group or a minimum dollar amount that must be reached for the offer to be finalized.

In some embodiments, the offer may be associate with a maximum value, such as a maximum number of participants. If it is determined that the maximum value is met, the group is closed and no more individuals may take advantage of the offer and join the group. If the maximum value is not met, the group remains open.

In some embodiments, the group members are invited by the group leader. The group may therefore be restricted such that only invitees may take part in the offer. For example, the group leader may enter email addresses of individuals, that he would like to join the group. Each of these invitees may be sent an email with a hyperlink for the address associated with the offer and group payment transaction.

In some embodiments the offer may be associate with a time limit. When the time limit is reached, the group may be closed.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary network environment in which embodiments of the invention may operate;

FIG. 2 is a block diagram of an exemplary computer system of some embodiments of the present invention;

FIG. 3 is a flow chart of an exemplary method performed by a group leader to initiate a group payment transaction in some embodiments of the present invention;

FIG. 4 is a flow chart of an exemplary method of implementing a group payment transaction in some embodiments of the present invention;

FIG. 5 is a flow chart of another exemplary method of implementing a group payment transaction in some embodiments of the present invention;

FIG. 6 is a schematic diagram illustrating parameters and components of a group payment system of some embodiments of the present invention.

### DETAILED DESCRIPTION

The inventors have recognized and appreciated that businesses will benefit if they are able to provide a social payment solution that allows group payments without requiring a single individual of the group to bear the entire responsibility of paying for an offer. Such group payment capabilities may be useful when purchasing luxury items or services, for example, chartering a boat or airplane, or renting a vacation home. A group payment system, such as described by some embodiments of the present invention, allows businesses to offer promotional deals at discounted rates to groups. A minimum number of people required in the group may be set, as well as a maximum number of people that are allowed to take part in the offer.

Group payment enables two or more people to share in the cost of a particular product, service or item for sale prior to the purchase. In some embodiments, payments are aggregated from individual group members and the seller or merchant receives a single remittance for the group sale transaction. The group may enjoy the offer as a group or individually, depending on how the group is set up.

Group payment is ideal for consumers to obtain higher priced items and/or offers that may be paid for or shared by two or more people. Merchants also benefit by allowing individuals to divide the cost of the offer without having to handle the collection of individual transactions. In some embodiments, a third party server may handle the individual credit card transactions and the details of the group payment transaction, while remitting payment to the merchant in a single transaction.

Embodiments of the invention may provide many benefits for both consumers and merchants, including: 1) All group members pay in advance of using the offer; 2) No group members are charged for the offer until the full amount of the offer is met; 3) No one group member is responsible for paying for the entire group and therefore responsible for recovering individual payments from other members of the group; 4) Communication is facilitated among group member; 5)Merchants are also not responsible for attaining payments from individual group members; 6) Merchant receives a single group sale, even though the actual sale was split between a plurality of group members.

Some embodiments may be implemented on a website accessible via the Internet. A group leader may initiate the group payment transaction. This may be accomplished, for example, by entering parameters associated with the offer into a website. The server hosting the website may be associated with a merchant or a third party that offers group payment as a payment option to merchants. If the website is hosted by a merchant's server, parameters may be automatically passed from the merchant's server to the group payment transaction server upon the group leader's initiation of a group payment transaction. In some embodiments, the parameters may be automatically generated by the merchant's server, with no additional input needed by the group leader. Embodiments of the present invention are not limited to particular parameters. Any suitable parameters may be used. For example, the parameters may be related to the minimum number of people required, the maximum number of people allowed, a time limit within which the offer will expire, the price of the offer for each individual, or any other information related to the offer.

In some embodiments, when the group leader initiates the group payment transaction he may enter contact information for individuals that he would like to invite to join the group. The contact information may be any suitable form of information. For example, it may be email addresses, telephone numbers or social network identifiers. In some embodiments, where email is used, email messages inviting each individual may then be sent. These email messages may include a hyperlink which each invitee may use to access the offer. However, embodiments of the present invention are not limited to “closed groups” that are available to invitees only. “Open groups” are also envisaged, where anyone may join the group. For example, an airline charter company may wish to use an open group to fill airplanes with customers interested in particular flights. Whereas a company, organization, or group of friends may be interested in a closed group for organizing an outing to sports events such as a baseball game.

Group members enter payment information to partake in the group offer. In some embodiments, each group member may pay the same amount, which may be determined by the group leader. In other embodiments, the group leader may set a minimum amount that each group member must pay, but any group member may choose to pay more than this minimum share. In this way, each individual group member may pay a different amount of money.

Embodiments of the present invention are not limited to any particular type of product or service. Other examples of offers that may benefit from the use of a group payment transaction our yacht rentals, renting private houses, renting a venue for party, a table reservation at a nightclub, and group tickets to theme parks.

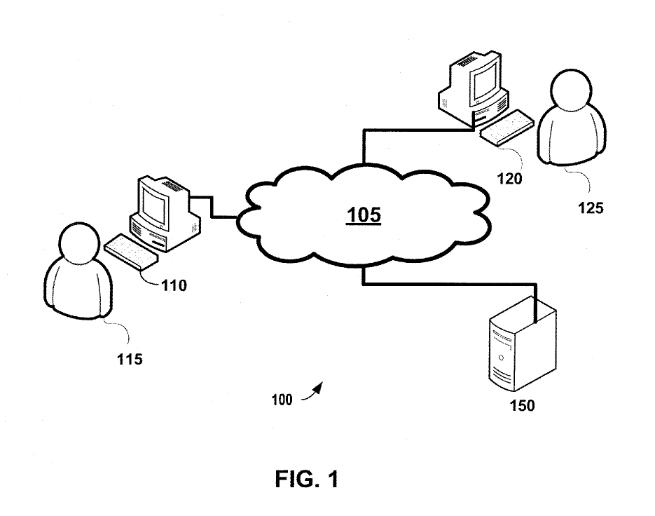

FIG. 1 illustrates an exemplary network environment 100, which may be used in implementing a group payment transaction. A group leader 115 may access a web site over a network 105, such as the Internet, via computer 110. The group leader may initiate the group payment transaction using the website. The group leader may enter a variety of parameters into the website, which will be transmitted via the network 105 to a server 150, where the parameters will be stored in a suitable way. In some embodiments, some or all of the parameters may be automatically generated by the computer 110 or server 150. For example, group leader 115 may enter the email address of invitee 125. It is preferable the group leader 115 enters a plurality of email addresses, but a single email address is used in the present discussion for the purposes of clarity. Server 150 may determine other parameters, such as the minimum number of participants required to form the group. Server 150 may then send an email to an email account associated with invitee 125 with information associated with the offer. Invitee 125 may access this email and request further information regarding the offer. The invitee may input his credit card information into computer 120. The credit card information will be sent over network 105 to server 150. Server 150 may then perform additional operations to implement the group payment transaction, such as pre-authorizing a payment on the invitee's credit card.

One of skill in the art would understand that computer 110, computer 120 and server 150 may be implemented by any suitable computing system. It is not limited to a single server and may be implemented by a plurality of servers. For example, a merchant's server may interact with a third party server to implement the group payment option. Moreover, network environment 100 is simplified for illustrative purposes. In many embodiments, the network 105 will have many more computer systems and there may be many more group members with computers accessing the website.

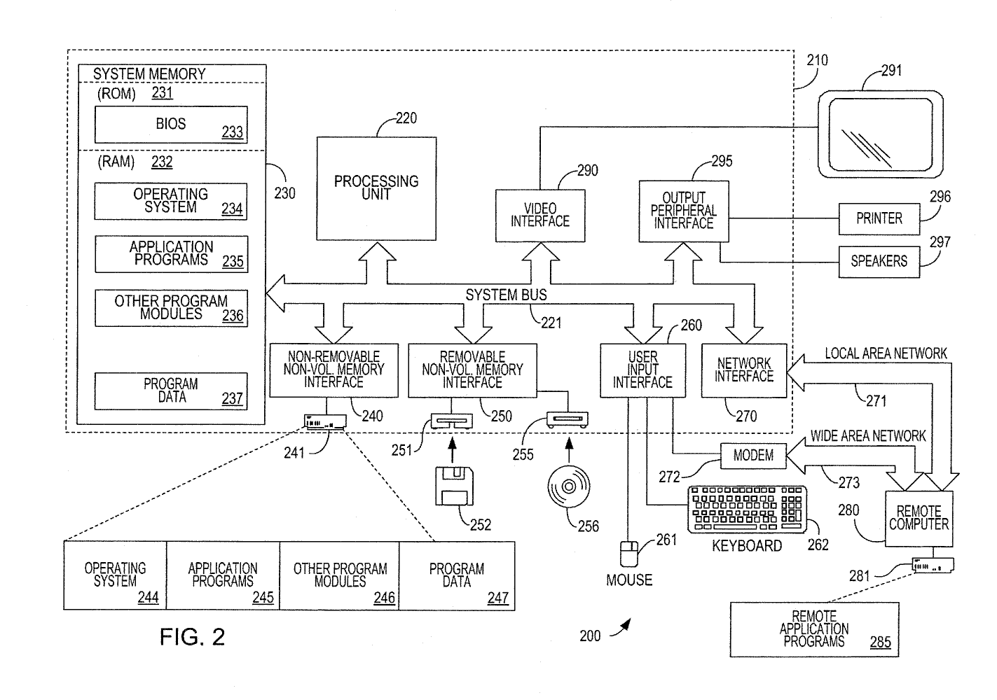

FIG. 2 illustrates an example of a suitable computing system 200 on which embodiments of the invention may be implemented. For example, computing system 200 may describe embodiments of computer 110, computer 120 and/or server 150 of FIG. 1. However, computing system 200 is only one example of a suitable computing system and is not intended to suggest any limitation as to the scope of use or functionality of the invention. Neither should the computing system 200 be interpreted as having any dependency or requirement relating to any one or combination of components illustrated in the exemplary computing system 200.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing embodiments of the invention includes a general purpose computing device in the form of a computer 210. Computer 210 is an example of a computer device that may implement a group payment transaction. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 120. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through an non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through a output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 121 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

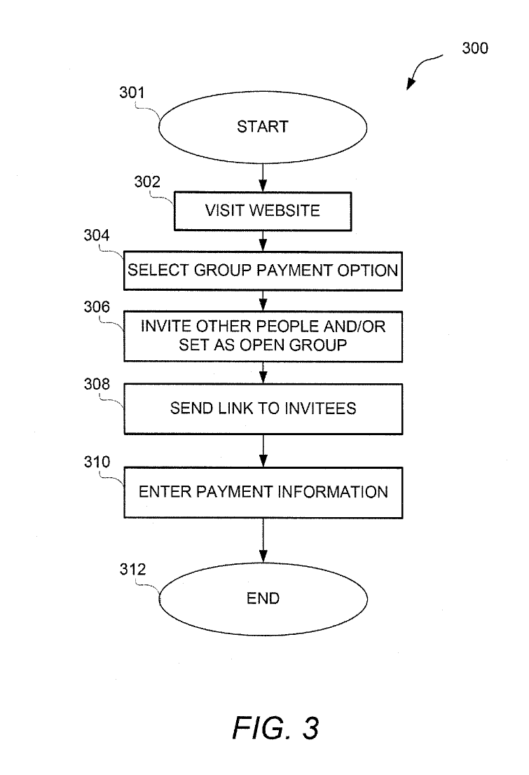

FIG. 3 illustrates an exemplary process 300 by which a group leader may initiate a group payment transaction. In some embodiments, process 300 may be performed by group leader 115 using computer 110 of FIG. 1. The process 300 begins at act 301. At act 302, the group leader may visit a website. Any suitable website may be used. For example, the website may be operated by a merchant or service provider. In other examples, the website may be a third party that provides group payment as a payment option for online merchants. In some embodiments, there may be multiple websites and servers involved. For example, a merchant's website, hosted on a merchant's server, may offer group payment by linking to a website of a third party on the third party's server or by implementing a plugin, module or application programming interface (API) provided by a third party to facilitate a group payment transaction on the merchant's website. Embodiments of this invention are not limited to any particular type of website.

The website may offer many forms of payment, of which group payment is one option. For example, the group leader may choose to purchase the offer outright, or opt to create a team for the purposes of sharing the cost of the offer. At act 304, the group leader selects group payment as the method of payment. Upon making this selection, the group leader may be given the option to invite other people to the group and/or make the group an “open group.” If the group leader decides to invite others to join the group at act 306, he may enter contact information for one or more invitees. Embodiments of this invention are not limited to any particular type of contact information. Any suitable contact information may be used. For example, the contact information may be an email address, a telephone number (which may or may not receive text messages), or a physical address, such as a home or business address. In some embodiments social networks such as Twitter™ or Facebook™ may be used to invite group members.

If an “open group” is selected, then any member of the public may join the group. If the group is by invitation only, then members of the public may be forbidden from joining the group without an invitation. This may be done in any suitable way. For example, invitees may be provided a unique code or password that gives them access to the offer and/or group. In some embodiments, invitees may also be invited when the group is an open group.

At act 308, after the contact information for the one or more invitees has been entered, information about the group and/or the offer may be sent to the one or more invitees. The information about the group and/or the offer may comprise a hyperlink leading to the website, or an associated website with information about the offer and/or the group, and provides an option for the invitee to join the group. The information may include a unique code or password that gives the invitees access to the offer and/or group. In some embodiments, the information about the group and/or the offer may be sent via email, text message, voice message, physical mail, or via a communication on a social networking platform. Embodiments of the invention are not limited to any particular type of communication. Nor are embodiments of the invention limited to any particular timing of when the information is sent to the invitees. For example, the invitation may be sent immediately to the invitee. In other embodiments, invitation may be sent to the invitees after some period of time or after some trigger event has occurred.

At act 310, if the group leader is participating in the group, the payment information for the group leader may be entered into the website. This may be done in any suitable way. In some embodiments, the payment amount for the group leader may default to the pro-rata share of the total cost of the offer. In some embodiments, the group leader may choose to pay more or less of this amount. In some embodiments, the group leader may be registered with the website and group leader's payment information may already be stored with the website. In other embodiments, the group leader may manually enter his credit card information to the website. However, in some embodiments the group leader may not be participating in the group. For example, the group leader may be the owner of a business such as a charter flight business and may wish to start a group for her customers to join. In this situation, the group may be initiated, but the group leader would not be a participating member of the group and therefore would not necessarily need to enter her payment information. The exemplary process 300 by which a group leader may initiate a group payment transaction terminates at act 312.

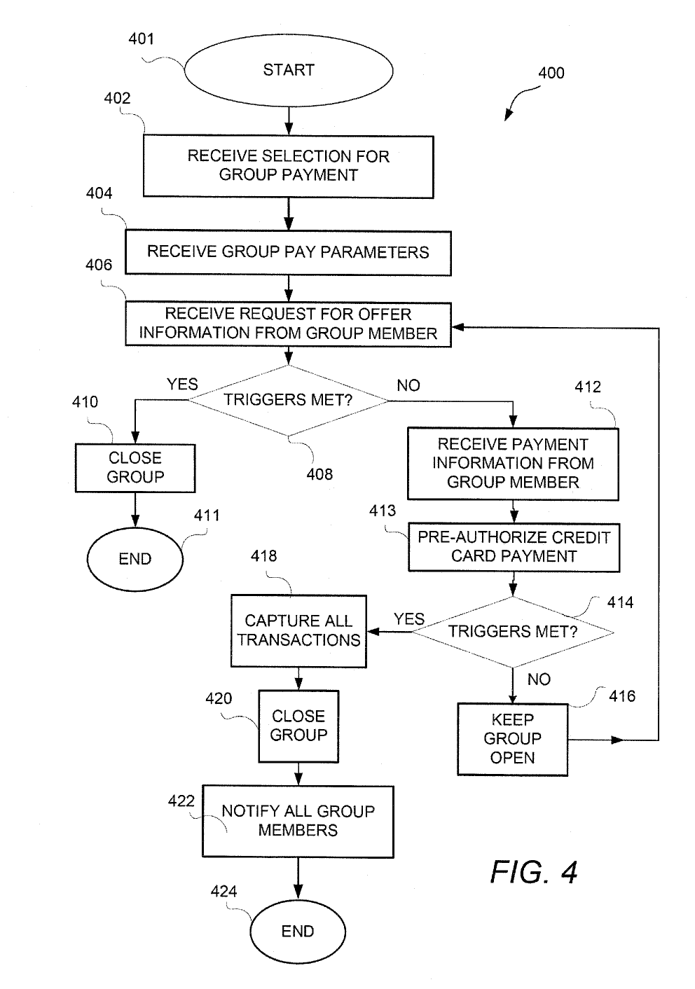

FIG. 4 illustrates an exemplary method 400 of implementing a group payment transaction in some embodiments of the present invention. Method 400 may be implemented in any suitable way. In some embodiments, method 400 may be performed by server 150, or by a combination of server 150 computer 110 and computer 120 of FIG. 1. In some embodiments, server 150 may comprise multiple servers acting together to perform the method. Method 400 begins at act 401.

At act 402, server 150 may receive a selection for group payment. This selection may be received, for example, over network 105 from user 115 using computer 110. In some embodiments, the selection may be a payment selection from a website offering a product or service for sale. The website may be a website hosted by server 150, or may be hosted by a different server. For example, server 150 may be associated with the group payment transaction, but the website that hosts the website selling the offer may be associated with a different server and/or a different company altogether. This may be the case in the situation where group payment is offered as a plug-in by a company for merchants to use as a payment option. Embodiments of this invention are not limited to receiving the group payment information at any particular computer or location.

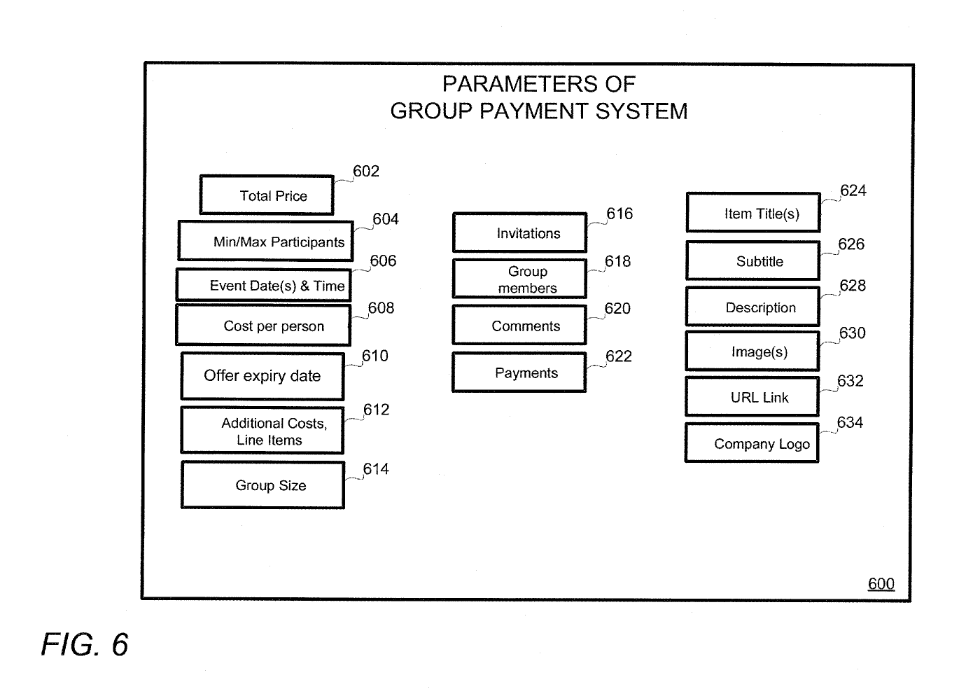

At act 404, server 150 may receive parameters associated with the group payment transaction. These parameters may be received at the same time as a selection for group payment in act 404, or at a different time. The parameters may be entered by a group leader and/or automatically determined by a merchant server that then communicates the parameters to the group payment transaction server. In some embodiments, one or more of the parameters may be automatically generated by the group payment transaction server. Any number and type of parameters may be associated with the group payment transaction. Example parameters that may be received are shown in FIG. 6. The parameters may include the total price 602 of the offer, the minimum number of group members required to form the group 604, the maximum number of group members allowed in the group 604, event date(s) and time 606, the price per group member 608, an expiry date 610 for the offer, any additional costs 612 or extras that may be added on later, the size of the group 614, a title for the offer 624, a subtitle 626, a description of the offer 628, one or more images 630 associated with the offer, a URL hyperlink 632 associated with the offer, and a company logo 634 associated with the company hosting the offer. Embodiments are not limited to include all of these parameters. Any suitable additional parameters may also be included.

Act 402 and act 404 initiate the group payment transaction. After the group payment transaction is initiated, requests for offer information may be received from prospective group members at act 406. Any suitable way for requesting information may be used. For example, the request may be in the form of the prospective group member visiting a website associated with the group payment transaction and/or the offer. If, for example, the prospective group member was invited by the group leader, then the prospective group member may request information about the offer by clicking a hyperlink in the invitation or visiting a website sent along with the invitation. In some embodiments, an invitee may be asked to enter a unique code or password that authorizes the invitee to view the offer. In other embodiments, the group may be an open group and any member of the public may become a group member. For example, a prospective group member may request information about an offer by clicking an online advertisement on a website. Embodiments are not limited to any particular mechanism for requesting information about the offer.

At act 408, in response to receiving a request for information about the offer, it is determined whether one or more triggers are satisfied. Any suitable triggers may be used. In some embodiments, the triggers may be associated with one or more of the parameters received at act 404. For example, the expiry date 610 may be used as a trigger. In other embodiments, a trigger not associated with the parameters received at act 404 may be used. For example, if a merchant is using the group payment transaction server 150 to implement group payment as an option, the trigger may be associated with whether the merchant is still in good standing with the operator of the group payment transaction server 150. Embodiments of the invention are not limited to any particular type of trigger.

If it is determined at act 408 that the one or more triggers are satisfied, then method 400 continues to act 410 where the group is closed. By closing the group, no additional group members may join the group. For example, if the trigger was the expiry date of the offer, then upon receiving a request about the offer, it will be determined that the offer has expired and the group is closed. In some embodiments, the requestor of the information about the offer will be notified that the group is closed. For example, the requestor may be notified that the maximum number of participants was reached, if the trigger used in act 408 was the maximum number of participants allowed for the offer. If the group is closed, then method 400 ends at act 411.

If it is determined at act 408 that the one or more triggers are not satisfied, then method 400 may continue at act 412 where payment information from the prospective group member is received. The payment amount may be determined in any suitable manner. In some embodiments, the payment amount for each group member may default to the pro-rata share of the total cost of the offer. In some embodiments, the group member may choose to pay more or less of this pro-rata share. Embodiments of the invention are not limited to any particular monetary amount. In some embodiments, the prospective group member enters and submits credit card information via a website. The credit card information is then received at a server associated with the group payment transaction. In other embodiments, credit card information may be given to a human operator over the telephone. Embodiments are not limited to any particular way of receiving payment information. For example, the merchant website or the group payment transaction may already have the group member's credit card information stored in a database of information such that the group member is not required to enter credit card information every time he chooses to participate in a group.

In response to receiving payment information from the prospective group member he becomes a fully-fledged group member and, at act 413, the group member's credit card is pre-authorized for the agreed to amount for the group member to participate in the offer. This amount may be the same for every group member or may be different based on a variety of factors. For example, a group member may choose to pay more to cover the costs of other participating group members. The credit card transaction for the group member is not finalized and posted to the account at this time. This finalization occurs at a later time.

In some embodiments, the group leader and/or existing group members may be notified when a new member joins the group. This may be done in any suitable way. For example, the group leader and/or group members may receive an email or a text message. In other embodiments, he may receive a social networking communication, such as a Facebook™ notification. Embodiments of the invention are not limited to a particular type of notification.

At act 414, it is determined whether one or more additional triggers are met. This may be done in any suitable way and any suitable triggers may be used. For example, the trigger may be the minimum number of participants required for the group. If the one or more triggers are not met, the group is kept open at act 416 and method 400 loops back to act 406 where an additional request for information is received from a different prospective group member. Method 400 then continues until the group is closed at act 410 or the one or more triggers are met at act 414.

If, at act 414, it is determined that the one or more triggers are met, then method 400 continues to act 418 where all the credit card transactions that have been pre-authorized for a plurality of group members that have submitted their credit card payment information are captured and finalized in a single batch such that either all of the pre-authorized transactions are captured at act 418, or, if the group is closed at act 410 (due to, for example, the expiry time of the offer having been reached) then none of the pre-authorized credit card payments are finalized and each of the plurality of group members is not charged for the offer. By implementing process 400 in this way, either all group members are charged for the offer or no group members are charged for the offer based on whether the group meets the requirements specified by the group leader when the group payment transaction was initiated.

In some embodiments, a merchant then receives remittance in a single payment. This may be done in any suitable way at any suitable time. For example, if the merchant uses a third party group payment transaction server, payment may be remitted from the third party to the merchant. This payment may be remitted when the group closes, when the credit card transactions are finalized, or at any suitable later time. Embodiments of the invention are not limited in this manner.

In some embodiments, the group is closed at act 420. This may be done in any suitable way. The group may be closed 420 before or after the transactions are captured in act 418. The exemplary method 400 illustrates the group being closed 420 after the pre-authorized transactions are captured 418. Closing the group prevents any additional group members from joining.

At act 422, the group members are sent notifications. Notifications may be sent in any suitable manner. In some embodiments, an email message is sent to an email address associated with each group member. In other embodiments, group members may be notified by ordinary mail, text message, social networking notification or by a phone call. The notification may comprise any suitable information. For example, the notification may notify each group member of the amount being charged to the credit card, the date and time of the event, and/or an expiry date by which the offer must be used or collected. In some embodiments, the names and/or contact information of other group members may be sent to each group member. Embodiments of the invention are not limited to any particular type or content of the notification.

Method 400 terminates at act 424. Method 400 is one exemplary embodiment of a method for implementing a group payment transaction. One of skill in the art would understand that any suitable substitution or variation is contemplated by the inventors. For example, the order of the acts that make up method 400 are not limited to occurring in the order shown in FIG. 4. Any suitable arrangement or order may be used. Furthermore, not all acts shown in FIG. 4 are necessary in every embodiment of the invention. Also, embodiments of the invention may incorporate other acts not shown in FIG. 4.

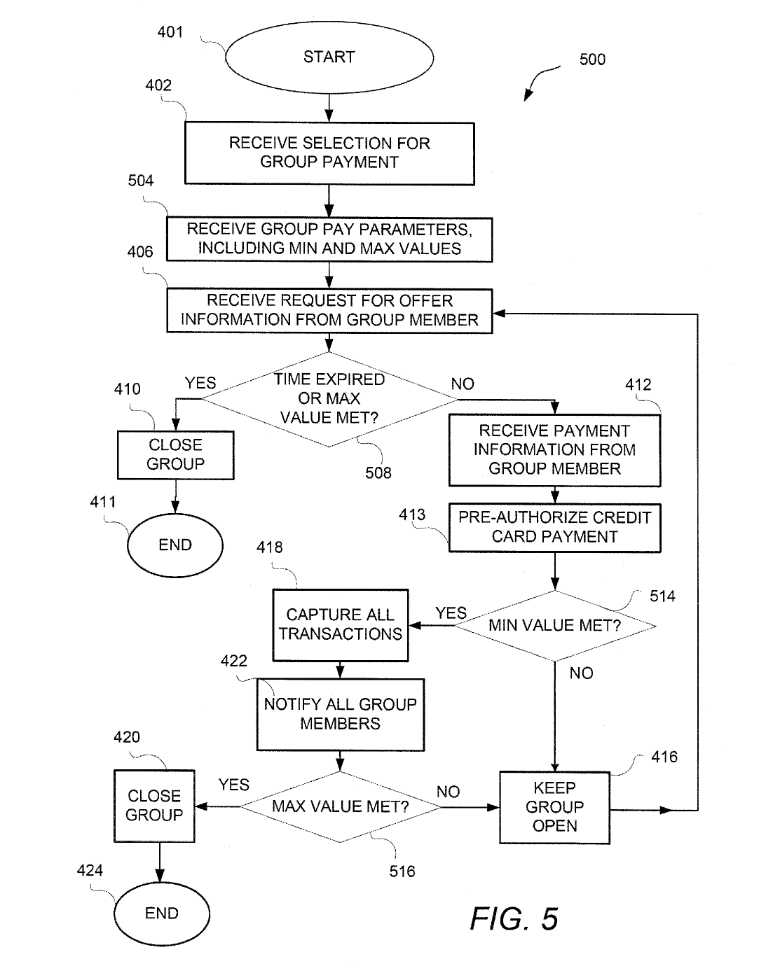

FIG. 5 illustrates another exemplary embodiment of implementing a group payment transaction. Items that are similar to acts already discussed in connection with method 400 of FIG. 4 are labeled with the same number in FIG. 5. These similar items are discussed briefly below and a more detailed description of each act may be found in the above discussion of FIG. 4.

Method 500 starts at act 401 and continues to act 402 where a payment selection of group payment is received. At act 504, group payment parameters are received. As discussed above in connection with act 404 of FIG. 4, any suitable parameters may be used. In particular, at least one pair of minimum and maximum values is received at act 504. In some embodiments this may be the minimum number of participants required to form a group and the maximum number of participants allowed in the group. In other embodiments, the minimum/maximum values may be a minimum amount of total money that is required for the offer to be completed and the maximum amount of total money that may be purchased by group members. Embodiments of the invention are not limited to any particular type of minimum and maximum values.

Method 500 continues at act 406, by receiving a request from a prospective group member for offer information. At act 508, it is determined whether the offer has expired or whether the maximum value has been met. This may be done in any suitable way. For example, the current date and time may be compared to the expiry date in time, which may have been provided as one of the received parameters. In some embodiments, there may be a maximum number of participants that the creator of the offer would like to be part of the group. For example, if the group leader is the owner of a charter flight business, then she may only have a certain number of seats on a particular flight. In another example, a group of friends may want to rent a vacation home and only a set number of people may be accommodated. In this case, the group leader may set the maximum number of people allowed so that more than the allowed number do not join the group. If the maximum value is met or the time has expired, then the group is closed and the method ends at act 411.

If the expiry date and time is not met at act 508, then method 500 continues at act 412 where payment information from the group member is received. This payment information may be received in any suitable way and comprises a credit card number. At act 413, the credit card is pre-authorized for a transaction amount, but the transaction is not finalized until a later time.

At act 514, it is determined whether the minimum value is met. Any suitable minimum value may be used. For example, it may be a minimum number of group members required to form a group or a minimum monetary amount required to finalize an offer and form a group. If it is determined that the minimum value is not met, then the group is kept open at act 416 and loops back to act 406 where a request for offer information is received from a different group member and portions of method 500 are repeated for this additional group member.

If the minimum value is met at act 514, then method 500 continues at act 418 by capturing all pre-authorized transactions. Capturing the transactions may comprise finalizing the transactions on each of the group members' credit cards. At act 422, the group members are notified. Notification may be done in any suitable way and may include a notification of the cost, the date and time of the event, and/or the names and contact information of other members of the group. Embodiments of the invention are not limited to any particular type or content of the notification.

At act 516, it is determined whether the maximum value is met. This may be done in any suitable way, as discussed above. In some embodiments, the number of current group members may be compared to the maximum allowed number of group members received as one of the group payment parameters in act 504. Embodiments of the invention are not limited to any particular maximum value. For example, the maximum value may be a monetary amount or any other suitable value.

If the maximum value is met, then the group is closed at act 420 and method 500 terminates at act 424. However, if the maximum value is not met at act 516, then the group is kept open at act 416 and execution of method 500 loops back to act 406 where additional group members may request information about the group offer. This additional check of the maximum value at act 516 in conjunction with keeping the group open at act 416 allows method 500 to keep accepting new members to the group even after the minimum value is satisfied and the maximum value is not yet met. In some embodiments, each additional transaction after the minimum value is met is finalized immediately and processed like a standard credit card charge. In other embodiments, the additional group members that join the group after the minimum value is met may be pre-authorized and finalized in a single batch after the maximum value is met. Embodiments of the invention are not limited to any particular manner of processing these additional transactions.

FIG. 4 and FIG. 5 are but two exemplary processes for implementing a group payment transaction. Additional embodiments of the invention may include variations of the aforementioned embodiments. For example, certain acts of the group payment process may be omitted or additional acts may be performed. In some embodiments, aspects of the discussed embodiments may be combined to form a different implementation of the group payment process.

FIG. 6 illustrates some parameters and components of a group payment system 600. Many of the parameters, which may be received, in some embodiments, from a group leader, were described above. The parameters may include the total price 602 of the offer, the minimum number of group members required to form the group 604, the maximum number of group members allowed in the group 604, event date(s) and time 606, the price per group member 608, an expiry date 610 for the offer, any additional costs 612 or extras that may be added on later, the size of the group 614, a title for the offer 624, a subtitle 626, a description of the offer 628, one or more images 630 associated with the offer, a URL hyperlink 632 associated with the offer, and a company logo 634 associated with the company hosting the offer. Embodiments are not limited to include all of these parameters.

Additional parameter of the group payment system 600 may comprise invitations 616 to be sent to invitees, the group members 618, comments 620 and payments 622. The group members 618 may comprise a name and/or contact information. In some embodiments, additional information about group members may be stored by system 600. For example, birthdate and demographic information may be stored. In some embodiments, payment information may be stored for each group member. If payment information is stored for a group member, then credit card information does not need to be sent to the group payment system for each purchase made by the group member. This allows joining a group and taking advantage of an offer to be quick and easy.

Comments 620 may comprise comments made by other group members, the group leader or prospective group members. For example, in some embodiments, the comments may be displayed on a website associated with the offer. This allows members of the group to communicate about the offer. For example, one group member may post a review about the product, service or the business offering the product or service.

Payments 622 may include any of the payment information described above. In some embodiments, payments 622 may comprise credit card information, such as credit card number, expiration date of the credit card, security codes, billing address, or any other suitable information.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a DVD, a tape, a hard disk drive, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures, such as tables, may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for implementing a group payment transaction for an offer, wherein the offer is purchased by a plurality of group members, the method comprising acts of:
initiating the group payment transaction, wherein initiating comprises opening a group that the plurality of group members may join;
receiving first credit card information of a first credit card from a first group member of the plurality of group members, wherein the first credit card information comprises at least a first credit card number;
pre-authorizing a first payment of a first amount on the first credit card;
receiving second credit card information of a second credit card from a second group member of the plurality of group members, wherein the second credit card information comprises at least a second credit card number;
pre-authorizing a second payment of a second amount on the second credit card;
determining whether at least one trigger value is satisfied, wherein the trigger value is associated with the offer;
if it is determined that the at least one trigger value is satisfied:
capturing at least the first payment and the second payment, wherein capturing at least the first payment and the second payment comprises finalizing the transactions for the first credit card and second credit card;
if it is determined that the at least one trigger value is not satisfied:
not capturing the first payment and the second payment; and
keeping the group open.

2. The method of claim 1, further comprising an act of:
if it is determined that the at least one trigger value is satisfied, closing the group.

3. The method of claim 1, further comprising acts of:
if it is determined that the at least one trigger value is satisfied, determining whether a maximum value is met;
if the maximum value is not met, keeping the group open; and
if the maximum value is met, closing the group.

4. The method of claim 3, wherein the maximum value is a maximum number of group members

5. The method of claim 1, wherein the at least one trigger value comprises a minimum number of people required to purchase the offer and/or a minimum amount of pre-authorized transaction amounts required to purchase the offer.

6. The method of claim 1, wherein the act of initiating the group payment transaction is done in response to receiving a request to initiate the group payment transaction from a group leader.

7. The method of claim 6, wherein:
the request to initiate the group payment transaction is received from the group leader via a website; and
the request comprises a plurality of parameters associated with the group payment transaction, wherein the plurality of parameters comprise the at least one trigger value.

8. The method of claim 1, further comprising an act of:
inviting the plurality of group members to join the group.

9. The method of claim 8, wherein:
the act of inviting comprises sending emails to email addresses of the plurality of group members; and
the email addresses of the plurality of group members is provided by the group leader.

10. The method of claim 1, further comprising acts of:
determining whether a time limit is met;
if the time limit is met, closing the group; and
if the time limit is not met, keeping the group open.

11. At least one computer storage medium encoded with instructions that, when executed by a computer system, perform a method for implementing a group payment transaction for an offer, wherein the offer is purchased by a plurality of group members, the method comprising acts of:
initiating the group payment transaction, wherein initiating comprises opening a group that the plurality of group members may join;
receiving first credit card information of a first credit card from a first group member of the plurality of group members, wherein the first credit card information comprises at least a first credit card number;
pre-authorizing a first payment of a first amount on the first credit card;
receiving second credit card information of a second credit card from a second group member of the plurality of group members, wherein the second credit card information comprises at least a second credit card number;
pre-authorizing a second payment of a second amount on the second credit card;
determining whether at least one trigger value is satisfied, wherein the trigger value is associated with the offer;
if it is determined that the at least one trigger value is satisfied:
capturing at least the first payment and the second payment, wherein capturing at least the first payment and the second payment comprises finalizing the transactions for the first credit card and second credit card;
if it is determined that the at least one trigger value is not satisfied:
not capturing the first payment and the second payment; and
keeping the group open.

12. The at least one computer storage medium of claim 11, wherein the method further comprises an act of:
if it is determined that the at least one trigger value is satisfied, closing the group.

13. The at least one computer storage medium of claim 11, wherein the method further comprises an act of:
if it is determined that the at least one trigger value is satisfied, determining whether a maximum value is met;
if the maximum value is not met, keeping the group open; and
if the maximum value is met, closing the group.

14. The at least one computer storage medium of claim 11, wherein the act of initiating the group payment transaction is done in response to receiving a request to initiate the group payment transaction from a group leader.

15. The at least one computer storage medium of claim 14, wherein:
the request to initiate the group payment transaction is received from the group leader via a website; and
the request comprises a plurality of parameters associated with the group payment transaction, wherein the plurality of parameters comprise the at least one trigger value.

16. The at least one computer storage medium of claim 11, wherein the method further comprises an act of:
inviting the plurality of group members to join the group, wherein the act of inviting comprises sending emails to email addresses of the plurality of group members and the email addresses of the plurality of group members is provided by the group leader.

17. The at least one computer storage medium of claim 11, wherein the method further comprises acts of:
determining whether a time limit is met;
if the time limit is met, closing the group; and
if the time limit is not met, keeping the group open.

18. A computer system for implementing a group payment transaction for an offer, wherein the offer is purchased by a plurality of group members, the computer system comprising:
a network interface for:
receiving a request to initiate the group payment transaction;
receiving first credit card information of a first credit card from a first group member of the plurality of group members, wherein the first credit card information comprises at least a first credit card number; and
receiving second credit card information of a second credit card from a second group member of the plurality of group members, wherein the second credit card information comprises at least a second credit card number;
a processor, operably coupled to the network interface for:
pre-authorizing a first payment of a first amount on the first credit card;
pre-authorizing a second payment of a second amount on the second credit card;
determining whether at least one trigger value is satisfied, wherein the trigger value is associated with the offer;
if it is determined that the at least one trigger value is satisfied:
capturing at least the first payment and the second payment, wherein capturing at least the first payment and the second payment comprises finalizing the transactions for the first credit card and second credit card;
if it is determined that the at least one trigger value is not satisfied:
not capturing the first payment and the second payment; and
keeping the group open.

19. The computer system of claim 18, wherein the processor:
if it is determined that the at least one trigger value is satisfied, determines whether a maximum value is met;
if the maximum value is not met, keeps the group open; and
if the maximum value is met, closes the group.

20. The computer system of claim 18, wherein the processor:
determines whether a time limit is met;
if the time limit is met, closes the group; and
if the time limit is not met, keeps the group open.
